(19) United States
(12) Patent Application Publication
(10) Pub. No.: US 2012/0173749 A1
(43) Pub. Date: Jul. 5, 2012

(54) Apparatus and Method for Providing On-Demand Multicast of Live Media Streams

(76) Inventor: Kunal Shah, San Francisco, CA (US)

(21) Appl. No.: 12/983,696

(22) Filed: Jan. 3, 2011

(51) Int. Cl. G06F 15/16

(52) U.S. Cl. 709/231

(57) ABSTRACT

A network router includes a communications interface that receives a request from a user terminal for a live media stream. The request includes a Uniform Resource Identifier (URI) identifying media content on a server and a terminal identifier identifying the user terminal. Upon receiving the request, a controller at the router determines whether the router is currently sending the live media stream to another user terminal. If the router is currently sending the live media stream to another user terminal, the router does not forward the request to the content server. Instead, the router replicates the live media stream and sends the replicated live media stream to the user terminal.

### FIELD OF THE INVENTION

The present invention relates generally to network routers, and particularly, to network routers that broker requests for live media streams between a content server that provides the live media streams and the user terminals that request the live media streams.

### BACKGROUND

Media traffic, such as streaming video and audio traffic, currently represents the largest percentage of Internet traffic. Further, the demand for video and audio streaming is rapidly increasing. Content such as TV and radio programming, for example, are now being streamed live across the Internet at the same time they are broadcast to viewers via their cable and satellite providers. For example, the Indian Premiere League (IPL), a popular cricket series, was recently streamed live to YOUTUBE. This marked the first time that a sports tournament was made available to viewers live via the Internet. Similarly, both the PGA Golf Tournament and the US Open were recently streamed to viewers via the Internet, with the U.S. Open 2010 being made available for viewing on the US Open website. In fact, ESPN3 is a live sports broadband network that streams worldwide live sports events for most any sport occurring to online viewers all over the world.

Typically, a live media stream is uploaded to a content server at the same time it is streamed over the Internet to one or more registered viewers. The content server can be located anywhere in the world and there is no maximum number of viewers that are able to view the live feeds. Generally, an end user receives the live media stream of an event at substantially the same time as the event occurs. The only delay in delivering the media stream to the end users is the delay that occurs between the time of creation of the media content (i.e., the recording of the live event) and the time it is uploaded to the server.

Although beneficial, there are some technological problems that must be addressed in order to stream live media content. For example, the live programs cannot be multicast to viewers because not all Internet Service Providers (ISPs) that handle the stream along the way support multicasting services. Additionally, it is not currently possible to dynamically map a media stream to a multicast channel and have the host that provides the media stream subscribe to the channel. Therefore, the live media streams are typically “unicast” to viewers. That is, each registered viewer establishes a separate stream with the content server to receive the same live media stream.

Providing each registered viewer with their own copy of the same live media stream via their own dedicated stream is a waste of network resources. Particularly, in some cases, the media streams travel through the network from the content server to an edge router before being delivered to the viewer. If several viewers are geographically near each other, it could mean that a single router would receive multiple copies of the same media stream originating from the same content server. Additionally, the content servers that host the live media streams (i.e., the owners of the content) mandate that the streamed content not be cached at the router.

### SUMMARY

The present invention provides an efficient method and apparatus for delivering a live media stream hosted at a network content server to multiple user terminals. Particularly, a network router disposed between the user terminals and the content server brokers requests for the live media stream. However, rather than receive separate, dedicated live media streams from the content server for delivery to each of the multiple user terminals, as is conventional, a router configured according to the present invention receives only one live media stream from the content server. For delivery to a plurality of user terminals, the router replicates the media stream for delivery to each user terminal. In this manner, the present invention reduces the load on the network content server, as well as the load or traffic on the network.

Accordingly, in one embodiment, the present invention provides a method for delivering a live media stream to a user terminal. In this embodiment, a network router intercepts a request from a first user terminal for a live media stream provided by a content server. The request includes a Uniform Resource Identifier (URI) that identifies the live media stream at the content server and a terminal identifier that identifies the first user terminal. Upon intercepting the request, the router first checks the contents of a memory to determine whether it is currently sending the live media stream to one or more different, user terminals. If the check reveals that no other user terminals are receiving the requested live media stream, the router will obtain the live media stream from the content server for delivery to the user terminal. The router will not cache the content of the live media stream. However, if the check reveals that the router is already delivering the live media stream to one or more other user terminals, the router will not forward the request to the content server. Instead, the router will replicate the requested live media stream and deliver the replicated stream to the requesting user terminal.

The present invention also provides a network router configured to deliver a live media stream to multiple user terminals. The network router comprises a communications interface and a controller. The communications interface connects the router to a content server hosting a live media stream and to one or more user terminals that request the live media stream hosted by the content server. The controller is configured to cause the router to deliver the live media stream to user terminals based on the number of users that are already receiving the same media stream.

Particularly, in one embodiment, the controller intercepts a request from a first user terminal for a live media stream provided by a content server. The request includes a Uniform Resource Identifier (URI) that identifies the live media stream at the content server and a terminal identifier that identifies the first user terminal. Based on data stored in a memory accessible to the router, the controller determines whether the router is currently delivering the same live media stream to one or more other user terminals. If not, the controller will obtain the live media stream from the content server and deliver the requested live media stream to the user terminal without caching the content. If so, however, the controller will not forward the request to the content server, but instead, replicate the live media stream at the router and deliver it to the requesting user terminal.

In another embodiment performed at a network server, the present invention provides a method for sending live media streams to a user terminal. Particularly, the server receives a user request for a media stream from the user via a network router. In addition to providing the requested media stream to the router for delivery to the user, the server generates a response for the router that includes multiple parameters. A first parameter includes an indicator that identifies the requested media stream as a live media stream. A second parameter is a Uniform Resource Identifier (URI) identifying the live media stream at a content server. The response is sent to the router along with the live media stream. The router will maintain the received parameters in a memory and use those parameters to make decisions responsive to receiving subsequent requests for the live media stream. Particularly, the router will decide whether to replicate the live media stream at the router for delivery to user terminals, or to obtain the live media stream from the content server for delivery to the user terminals, based on the stored parameters.

Of course, those skilled in the art will appreciate that the present invention is not limited to the above contexts or examples, and will recognize additional features and advantages upon reading the following detailed description and upon viewing the accompanying drawings.

### BRIEF DESCRIPTION OF THE DRAWINGS

FIG. 1 illustrates an exemplary communication system suitable for use in one embodiment of the present invention.

FIG. 2A is a flow chart illustrating an exemplary method of performing the present invention according to one embodiment.

FIG. 2B is a flow chart illustrating an exemplary method of replicating a live media stream according to one embodiment of the present invention.

FIG. 2C is a flow chart illustrating an exemplary method of updating a memory to reflect which user terminals are still receiving the live media stream.

FIG. 3 is a block diagram illustrating some of the components of a router device configured to operate according to one embodiment of the present invention.

FIG. 4 is a block diagram illustrating some of the components of a server configured to operate according to one embodiment of the present invention.

### DETAILED DESCRIPTION

The present invention provides an apparatus and method for delivering a “live” media stream hosted at a content server to one or more user terminals. More particularly, a network router brokers requests for a live media stream between user terminals and the content server that hosts the requested stream. During operation, the network router collects and maintains information identifying the live media stream as well as the identities of the user terminals currently receiving the live media stream.

Whenever a user terminal requests to receive the live media stream, the network router uses the information to determine whether to forward the request to the content server to obtain the live media stream for delivery to the user terminal, or whether to forego sending the request to the content server, and instead, replicating the live media stream at the router for delivery to a user terminal. The latter choice eliminates the need for multiple streams from the content server to the network router, thereby reducing the load on the network and saving network resources.

In the context of the present invention, a media stream comprises any video and/or audio stream hosted at one or more content servers. A “live” media stream is therefore a video and/or audio stream of a live event (e.g., a sporting event or a concert) that is uploaded to the content server at substantially the same time that the event occurs. Although there may be some delay between when the subject media event actually occurs and when the corresponding “live” media stream is uploaded to the content server, a key feature of a “live” media stream is that it is not recorded or cached for replay on devices that handle the live media stream.

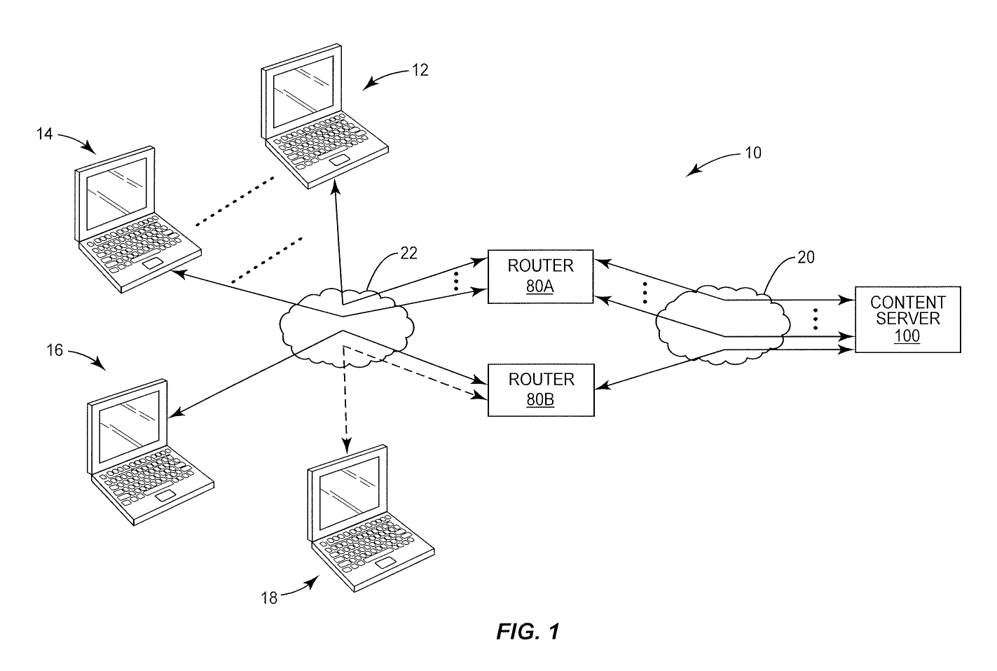

FIG. 1 is a diagram illustrating a communications network 10 suitable for use in one embodiment of the present invention. Data packets and information may be communicated between devices using any known protocol, such as the Internet Protocol (IP), the Transmission Control Protocol (TCP), and the User Datagram Protocol (UDP), for example. As seen in FIG. 1, a plurality of user terminals 12, 14, 16, 18 are communicatively connected to a content server 100 via one or more network routers 80a, 80b. As is known in the art, one or more public and/or private communication networks 20, 22, such as the Internet, for example, provide the logical and physical framework to carry packet data between the user terminals 12-18, the routers 80, and the content server 100. Applications executing on the user terminals 12-18, the routers 80, and the content server 100 may communicate using any known standards and protocols; however, in one embodiment, the applications executing on these devices communicate messages and/or data between themselves in accordance with one or more protocols such as the HyperText Transfer Protocol (HTTP), Fiber To The x (FTTx), IP, TCP, and UDP, for example.

Generally, each of the user terminals 12-18 are configured to generate and send request messages requesting the delivery of a live media stream hosted at the content server 100. In response to the request messages, the content server 100 provides the user terminals 12-18 with a response message and the live media stream. In one embodiment, the live media stream comprises an audio/video stream of a live event (e.g., a sporting event as it occurs). In another embodiment, the live media stream comprises an audio stream of a live event (e.g., a concert as it occurs). In both cases, the live media stream is first uploaded from a device used to capture the video and/or audio (e.g., a video camera or a microphone) to the content server 100 as the event occurs. The resultant live media stream is then made available via streaming to the user terminals 12-18 via the routers 80 and network 20, 22.

As previously stated, conventional methods of streaming live media to multiple user terminals is problematic. For example, conventional methods of providing live media streams to a plurality of user terminals unnecessarily utilize large amounts of network resources. The present invention, however, improves upon these conventional methods, and in particular, reduces the load on the network 10 and content server 100. FIG. 1 illustrates this contrast.

Particularly, user terminals 12, 14 independently generate respective HTTP request messages (e.g., HTTP GET messages) to request a live media stream. The messages may or may not be generated simultaneously. Each user terminal 12, 14 sends its request to the content server 100 via router 80a and networks 20, 22. In response, the content server 100 provides each user terminal 12, 14 with the requested live media stream via router 80a and networks 20, 22.

As seen in FIG. 1, conventional methods of providing the same live media stream to multiple user terminals causes the establishment of a separate, dedicated stream in network 20 for each of user terminal 12, 14. Similarly, the requests also cause the establishment of a separate, dedicated stream in network 22 for each of the user terminals 12, 14. Thus, with conventional methods, each user terminal 12, 14 would have its own dedicated stream established between it and the content server 100 to receive the same live media stream. This is wasteful as far as network resources are concerned.

The present invention reduces or eliminates this waste while still allowing multiple user terminals to receive the same live media stream. Particularly, when a first user terminal 16 generates a request (e.g., an HTTP GET) to obtain the live media stream via the router 80b, the content server 100 sends an HTTP response message including information about the live media stream content. According to the present invention, the router 80b intercepts the HTTP messages and extracts or copies predetermined parameters from the HTTP messages. The router 80b also saves these parameters to a memory accessible to the router 80b. The content server 100 will then send the live media stream to the user terminal 16 via the router 80b. Thereafter, whenever a subsequent user terminal (e.g., user terminal 18) generates and sends a HTTP GET message for the same live media stream, the router 80b extracts similar parameters from the subsequent request message and compares them to the extracted parameters stored in the memory to determine whether another user terminal is currently receiving the live media stream. If so, the router 80b is configured to refrain from sending the request generated by user terminal 18 to the content server 100, and instead, replicate the live media stream at the router. The replicated live media stream (indicated in FIG. 1 using the dashed line) is then provided to user terminal 18. As seen in FIG. 1, this still establishes separate streams between the router 80b and the user terminals 16, 18, but requires only a single dedicated stream in network 20 to carry the live media stream from the content server 100 to the router 80b, thereby reducing the load on content server 100 and the network resources.

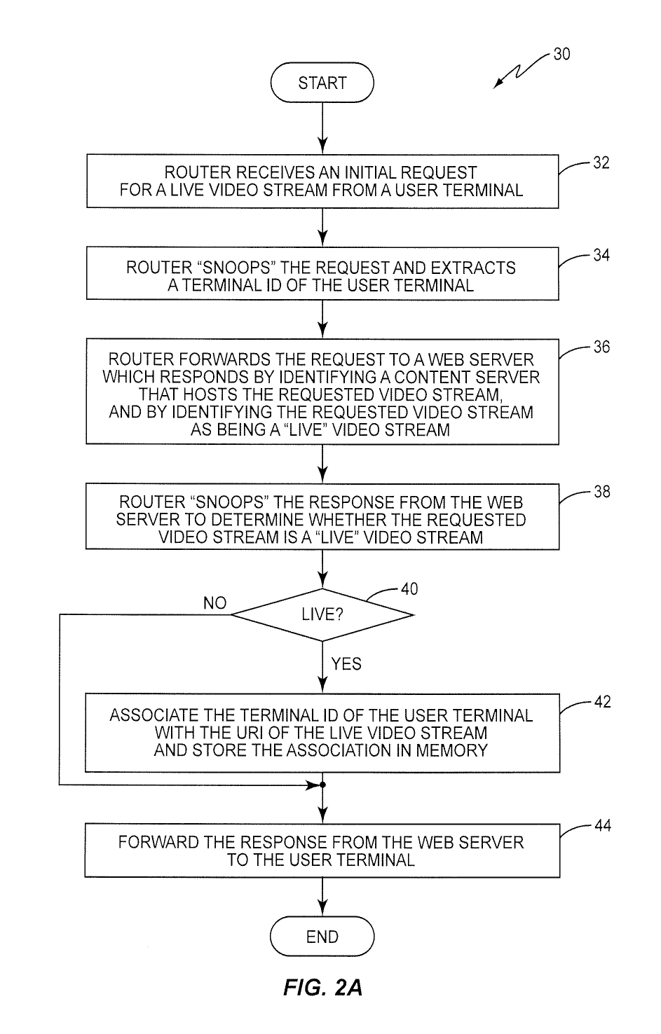

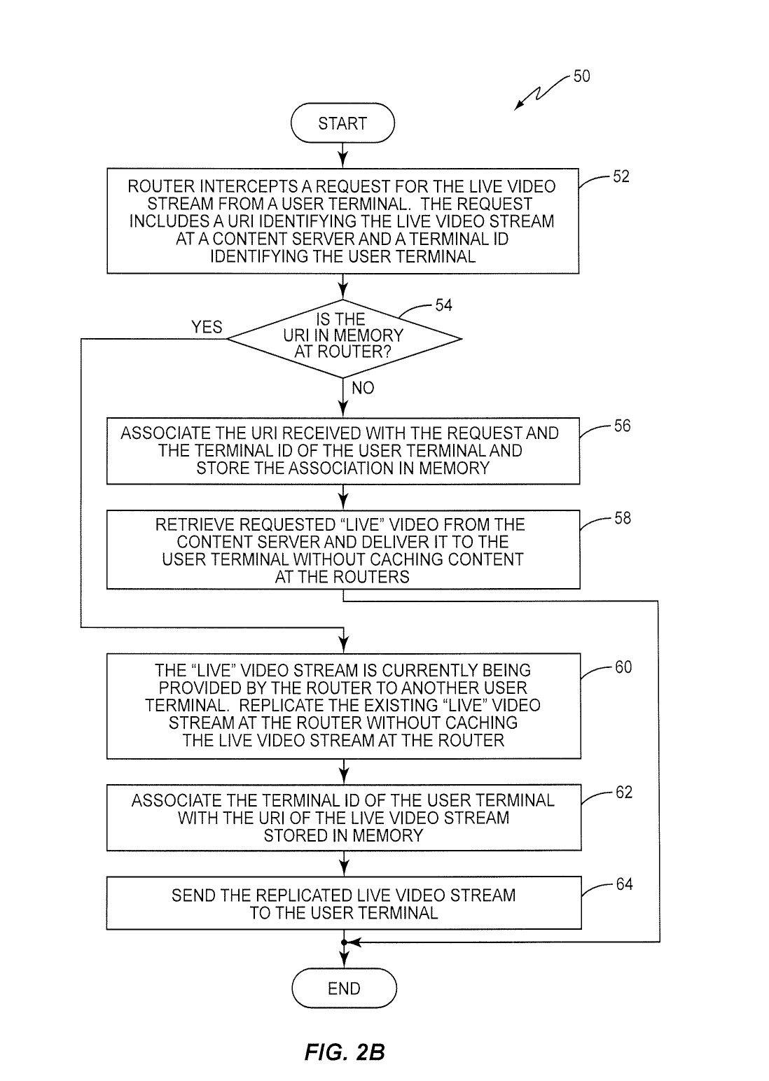

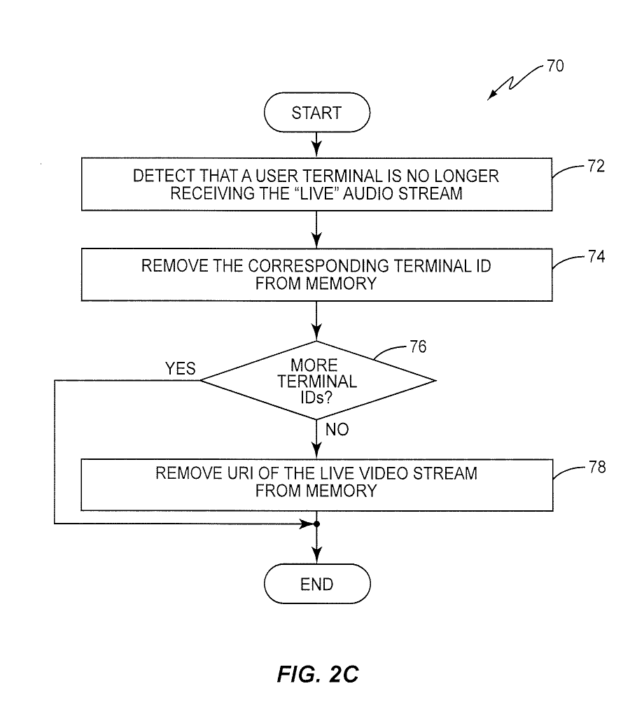

FIGS. 2A-2C are flow diagrams illustrating the method of the present invention in more detail. Particularly, FIG. 2A illustrates a method performed by router 80b upon receiving an initial request for the live media stream from a first user terminal (e.g., user terminal 16). FIG. 2B illustrates a method performed by router 80b upon receiving subsequent requests for the same live media stream from another user terminal (e.g., user terminal 18). FIG. 2C illustrates a method performed by router 80b of monitoring and updating which user terminals are still receiving the live media stream. As previously described, this information is used by a network router (e.g., router 80b) to determine whether to replicate a live media stream at the router for delivery to a user terminal, or whether to obtain the live media stream from the content server 100 for delivery to the user terminal.

The method 30 of FIG. 2A begins when router 80b receives an initial request message for a live media stream from a user terminal (e.g., an HTTP GET message generated by a browser application executing on user terminal 16) (box 32). The router 80b “snoops” the HTTP GET message and extracts a terminal ID that identifies user terminal 16 (box 34). Since this is an initial request for the live media stream (i.e., no other user terminals are currently receiving the live media stream), the router 80b will forward the request to a web server in the network. The web server, which may or may not be the content server 100, will respond to the HTTP GET message by generating and returning an HTTP RESPONSE message to user terminal 16 via router 80b. The HTTP RESPONSE message will include several parameters of interest to router 80b. Specifically, HTTP RESPONSE message will include a Uniform Resource Identifier (URI) that identifies the requested live media stream at the content server 100, and a special “LIVE” indicator that identifies the media stream at the URI as being a “live” media stream (box 36). These parameters may be placed anywhere in the HTTP messages, however, in one embodiment, the parameters are generated to insert into the header portion of the HTTP messages.

The router 80b “snoops” the HTTP RESPONSE message upon receipt and extracts the URI based on the LIVE indicator (box 38). If the requested media stream is not a live media stream (box 40), the router 80b will simply forward the HTTP RESPONSE to the user terminal (box 44). If, however, the requested media stream is indicated as being live (box 40), the router 80b will extract the URI from the HTTP response message and associate the URI with the terminal ID of user terminal 16. The association is then stored in a memory that is accessible to the router 80b (box 42). As seen later in more detail, the router 80 will maintain the association as long as user terminal 16 continues to receive the live media stream. Further, the router 80b will utilize this information to determine whether or not to forward future requests for the live media stream to the server. The router 80b will then forward the HTTP RESPONSE message to the user terminal 16 (box 44).

To obtain the media stream, the router 80b performs the method 50 seen in FIG. 2B. Generally, upon receipt of the HTTP RESPONSE message at a user terminal, a media rendering application (e.g., a FLASH or QUICKTIME application) will generate a request for the live media stream. The request will include the URI from the HTTP RESPONSE and the terminal ID of the user terminal generating the request.

Method 50 begins when the router 80b receives this request for the live media stream from a user terminal (e.g., an HTTP GET message from user terminal 16, 18) (box 52). Upon receipt, the router 80b will extract the URI and determine whether or not to obtain the live media stream from the content server 100. Specifically, the router 80b will compare the URI received from the user terminal to the URI stored previously by router 80b in memory (box 54). If the comparison indicates that no other user terminals are currently receiving the live media stream (i.e., this is the initial request generated by user terminal 16), the router 80b will associate the URI and the terminal ID received with the HTTP GET and store the association in a memory (box 56). The router 80b will then retrieve the live media stream from the content server 100 for delivery to the user terminal 16. The router 80b will not cache or save the requested live media stream in the memory (box 58).

If the comparison reveals that at least one other user terminal is receiving the live media stream (e.g., the URI exists in memory and is associated with at least one other terminal ID, such as that of user terminal 16) (box 54), the router 80b will not forward the request to the content server 100. Instead, the router 80b will replicate the existing live media stream at the router without caching the media stream (box 60). The router 80b will then associate the terminal ID (e.g., user terminal 18) to the URI and store the association in the memory (box 62). The router 80b will then send the replicated live media stream to the user terminal 18 (box 64).

Thus, the router 80b configured according to the present invention monitors which media streams are “live” media streams, and which user terminals are currently receiving the same live media stream. Based on that information, the router 80b will either forward a request for the live media stream to the content server 100 (i.e., on an initial request), or forego forwarding the request, and instead, replicate the live media stream at the router for delivery to the user terminal (i.e., on subsequent requests). Of course, the router 80b may or may not communicate information to the content server 100 providing data on the requesting user terminals to ensure that they are authorized to receive the media, and/or to help the content server 100 maintain a billing database.

The router will maintain and update the memory as necessary to ensure that the memory accurately reflects which user terminal(s) are currently receiving the live media stream. As seen in method 70 of FIG. 2C, for example, once router 80b detects that a user terminal (e.g., user terminal 18) is no longer receiving the live audio stream (box 72), the router 80b will remove the terminal ID corresponding to that user terminal 18 from the memory (box 74). If there are other terminal IDs still associated with the URI of the live media stream, the router 80b will exit the procedure and wait until the next time it detects that someone has stopped viewing the media stream. So long as there is at least one user terminal ID/URI association stored in the memory, the router 80b will continue to replicate the live media stream for subsequent requests. However, when the last remaining terminal ID associated with the URI is removed from the memory, the router 80 will also remove the URI from memory (box 76).

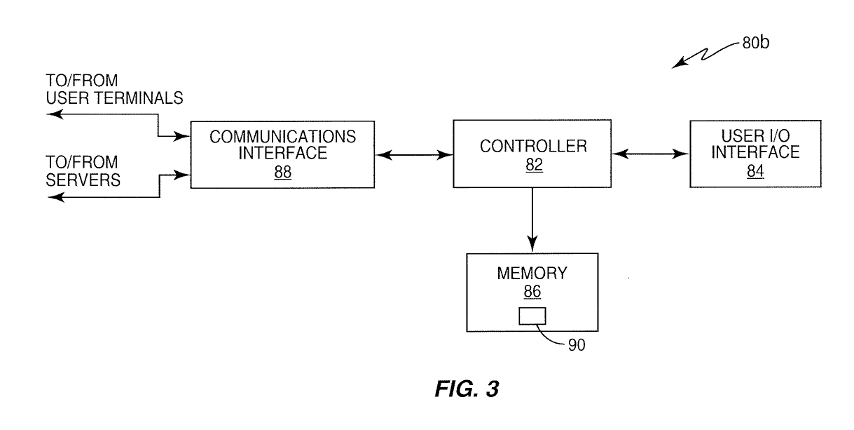

FIG. 3 illustrates some of the component parts of an exemplary router, such as router 80b, configured to function according to one embodiment of the present invention. Router 80b comprises a controller 82, a user interface 84, a memory 86, and a communication interface 88. Controller 82 may, for example, be implemented as a single microprocessor or multiple microprocessors. Suitable microprocessors may include, but are not limited to, general purpose and special purpose microprocessors as well as digital signal processors and/or image processors.

The controller 82 controls the operation of router 80b according to one or more programs and data stored in memory 86. Such programs and data, such as application 90, for example, may control the router 80b to perform functions such as communicate media streams and/or data with the user terminals 12-18 and/or the content server 100. As previously described, application 90 may cause the controller 82 to monitor which user terminals are currently receiving a given live media stream, and replicate the given media stream for at least some user terminals instead of obtaining all media streams from a content server. This includes the ability to “snoop” HTTP GET and HTTP RESPONSE messages to determine a URI and terminal IDs, as well as to determine whether a given media stream requested by the user terminals is a “live” media stream.

The User I/O Interface (UI) 84 generally includes one or more components that permit a network operator to interact with, and control the operation of, the router 80b. This may include, but is not limited to, one or more user controls such as knobs, switches, keys, button controls, or dials. Memory 86 is a computer readable medium representing the entire hierarchy of memory in router 80b, and may comprise both random access memory (RAM) and read-only memory (ROM). As previously stated, the computer program instructions and data required for operation of the router 80b are stored in non-volatile memory, such as EPROM, EEPROM, and/or flash memory. Memory 84 may be implemented, for example, as one or more discrete devices, stacked devices, or removable devices, such as a flash drive or memory stick, or may be integrated with controller 82. The communications interface 88 comprises any known interface that permits the router 80b to communicate data and/or live media streams with one or more user terminals 12-18, as well as content server 100.

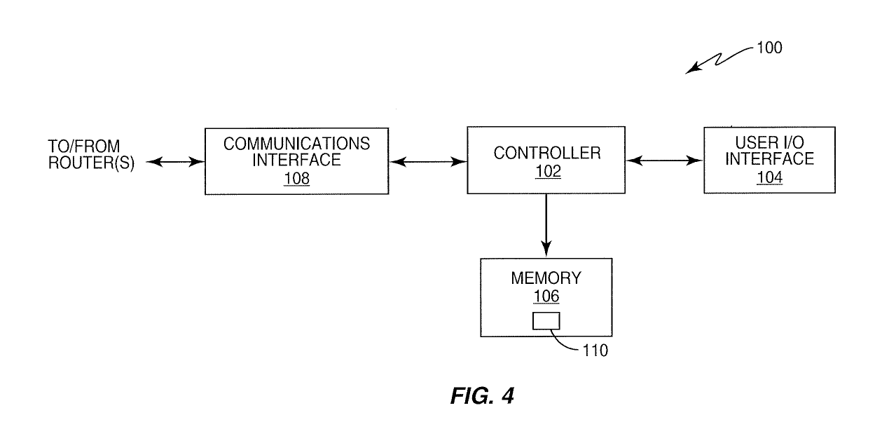

FIG. 4 is a block diagram illustrating some components of a server located in the network. The server may be, for example, content server 100 or some other server that identifies the URI of a requested media stream to the requesting user terminal. The server 100 comprises a controller 102, a user I/O interface 104, a memory 106, and a communications interface 108 that communicates with router 80b. A computer program application 110 may be stored in memory 106 to control the functions of the server 100.

The conventional functions of the components seen in FIG. 4 are substantially similar to those of the router 80b, and thus, are not described in detail here. It is sufficient to say, however, that the application program 110 may be executed by controller 102 indicate to router 80b which requested media streams are “live.” That is, the controller 102 may operate to generate HTTP RESPONSE messages that include a LIVE indicator in the header of the HTTP RESPONSE message identifying the requested media stream as being a live media stream.

The present invention may, of course, be carried out in other ways than those specifically set forth herein without departing from essential characteristics of the invention. For example, the network router described in the previous embodiments can intercept and extract parameters from communicated messages, but does not alter the messages. In other embodiments, however, the network router may be configured to function as a full-blown proxy. Further, the router seen in the previous embodiments can be, but is not required to be, an edge router. Thus, any network router disposed along the stream may be configured to function according to one or more embodiments of the present invention. Therefore, the present embodiments are to be considered in all respects as illustrative and not restrictive, and all changes coming within the meaning and equivalency range of the appended claims are intended to be embraced therein

What is claimed is:

1. A method of delivering a live media stream to a user terminal, the method comprising:
intercepting, at a network router, a request from a first user terminal for a live media stream provided by a content server, the request including a Uniform Resource Identifier (URI) identifying the live media stream at the content server and a terminal identifier identifying the first user terminal;
determining whether the router is currently sending the live media stream to a second user terminal; and
if the router is currently sending the live media stream to the second user terminal:
replicating the live media stream at the router; and
sending the replicated live media stream to the first user terminal.

2. The method of claim 1 wherein replicating the live media stream at the router comprises reproducing the media stream at the router without forwarding the request to the content server.

3. The method of claim 1 wherein determining whether the router is currently delivering the live media stream comprises:
extracting, from the received request, the URI of the live media stream at the content server; and
comparing the extracted URI to a URI stored by the router in a memory to determine whether the router is currently delivering the live media stream to the second user terminal.

4. The method of claim 3 further comprising:
associating the terminal identifier of the first user terminal with the URI stored by the router if the extracted URI matches the URI stored by the router; and
storing the association in the memory.

5. The method of claim 4 further comprising:
determining, at the router, that the live media stream is not being delivered to one or both of the first and second user terminals; and
deleting the corresponding terminal identifiers from the memory.

6. The method of claim 5 further comprising deleting the URI of the live media stream from the memory once the terminal identifiers of all user terminals associated with the URI have been deleted from the memory.

7. The method of claim 1 further comprising forwarding the request for the live media stream to the content server if the live media stream is not currently being delivered to one or more other user terminals.

8. The method of claim 7 further comprising:
associating the terminal identifier of the first user terminal with the URI of the live media stream;
storing the association in a memory;
retrieving the live media stream from the content server; and
sending the live media stream to the first user terminal without caching the live media stream at the router.

9. The method of claim 1 further comprising:
forwarding an initial request from the first user terminal for a media stream to the network server;
determining, at the router, whether the requested media stream is a live media stream based on a response from the network server;
if the requested media stream is a live media stream:
associating the terminal identifier of the first user terminal with the URI of the live media stream;
storing the association in a memory;
retrieving the live media stream from the content server; and
sending the live media stream to the first user terminal without caching the live media stream at the router.

10. The method of claim 9 wherein determining whether the requested media stream is a live media stream comprises inspecting a header of the response from the network server for the presence of an indicator identifying the requested media stream as a live media stream.

11. A network router for delivering a live media stream to a user terminal, the router comprising:
a communications interface configured to intercept a request from a first user terminal for a live media stream hosted by a content server, the request including a Uniform Resource Identifier (URI) identifying the live media stream at the content server and a terminal identifier identifying the first user terminal; and
a controller configured to:
determine whether the router is currently sending the live media stream to another user terminal; and
if the router is currently sending the live media stream to another user terminal:
replicate the live media stream at the router; and
send the replicated live media stream to the first user terminal.

12. The router of claim 11 wherein the controller is further configured to replicate the live media stream at the router without forwarding the request to the content server.

13. The router of claim 11 wherein the controller is further configured to store one or more URIs in a memory, each URI identifying a respective live media stream that is currently being sent to one or more user terminals.

14. The router of claim 13 wherein the controller is further configured to:
extract the URI of the live media stream from the received request; and
compare the extracted URI to the one or more URIs stored by the router to determine whether the router is currently sending the live media stream to another user terminal.

15. The router of claim 14 wherein the controller is configured to:
associate the terminal identifier of the first user terminal with a URI stored by the router if the extracted URI matches the URI stored by the router; and
store the association in the memory.

16. The router of claim 15 wherein the controller is configured to:
determine that the router is not sending the live media stream to one or more user terminals; and
delete the corresponding terminal identifiers from the one or more user terminals from the memory.

17. The router of claim 16 wherein the controller is further configured to delete the URI of the live media stream from the memory once the terminal identifiers of all user terminals associated with the URI have been deleted from the memory.

18. The router of claim 11 wherein the controller is further configured to forward the request for the live media stream to the content server if the live media stream is not currently being delivered to one or more other user terminals.

19. The router of claim 18 wherein the controller is further configured to:
associate the terminal identifier of the first user terminal with the URI of the live media stream;
store the association in a memory;
retrieve the live media stream from the content server; and
send the live media stream to the first user terminal without caching the live media stream at the router.

20. The router of claim 11 wherein the controller is further configured to:
forward an initial request from the first user terminal for a media stream to the network server;
determine whether the requested media stream is a live media stream based on a response to the initial request from the network server; and
if the requested media stream is a live media stream:
associate the terminal identifier of the first user terminal with the URI of the live media stream;
store the association in a memory;
retrieve the live media stream from the content server; and
send the live media stream to the first user terminal without caching the live media stream at the router.

21. The router of claim 20 wherein the controller is further configured to inspect a header of the response from the network server for the presence of an indicator that identifies the requested media stream as a live media stream.

22. A method for sending live media streams to a user terminal, the method comprising:
receiving a request for a media stream from a router;
generating a response to include a Uniform Resource Identifier (URI) of a live media stream at a content server, and an indicator that identifies the requested media stream as a live media stream; and
sending the response to the router.
